(19) United States
(12) Patent Application Publication
(10) Pub. No.: US 2007/0216779 A1
(43) Pub. Date: Sep. 20, 2007

(54) Data mangement of a data stream

(76) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(21) Appl. No.: 11/376,627

(22) Filed: Mar. 15, 2006

(51) Int. Cl. H04N 5/76

(52) U.S. Cl. 348/231.2; 348/231.4

(57) ABSTRACT

In one aspect, a method related to data management includes but is not limited to accepting input for designation of at least a portion of a data stream for retention at high resolution, wherein the data stream represents video and/or audio information. In addition, other method aspects are described in the claims, drawings, and/or text forming a part of the present application. Related systems are also disclosed.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled Imagery Processing, naming Edward K. Y. Jung, Royce A. Levien, Robert W. Lord, Mark A. Malamud, and John D. Rinaldo, Jr., as inventors, U.S. application Ser. No. 11/364,496, filed Feb. 28, 2006.

### TECHNICAL FIELD

The present application relates, in general, to data management.

### SUMMARY

In one aspect, a method related to data management includes but is not limited to accepting input for designation of at least a portion of a data stream for retention at high resolution, wherein the data stream represents video and/or audio information. In addition to the foregoing, other method aspects are described in the claims, drawings, and text forming a part of the present application.

In one aspect, a system related to data management includes but is not limited to circuitry for accepting input for designation of at least a portion of a data stream for retention at high resolution, wherein the data stream represents video and/or audio information. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for accepting input for designation of at least a portion of a data stream for retention at high resolution, wherein the data stream represents video and/or audio information. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts one implementation of an exemplary environment in which the methods and systems described herein may be represented;

FIG. 2 depicts a high-level logic flowchart of an operational process;

FIG. 3 shows several alternative implementations of the high-level logic flowchart of FIG. 2;

FIG. 4 shows several alternative implementations of the high-level logic flowchart of FIG. 3;

FIG. 5 shows several alternative implementations of the high-level logic flowchart of FIG. 3; and

FIG. 6 shows several alternative implementations of the high-level logic flowchart of FIG. 3.

The use of the same symbols in different drawings typically indicates similar or identical items.

### DETAILED DESCRIPTION

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

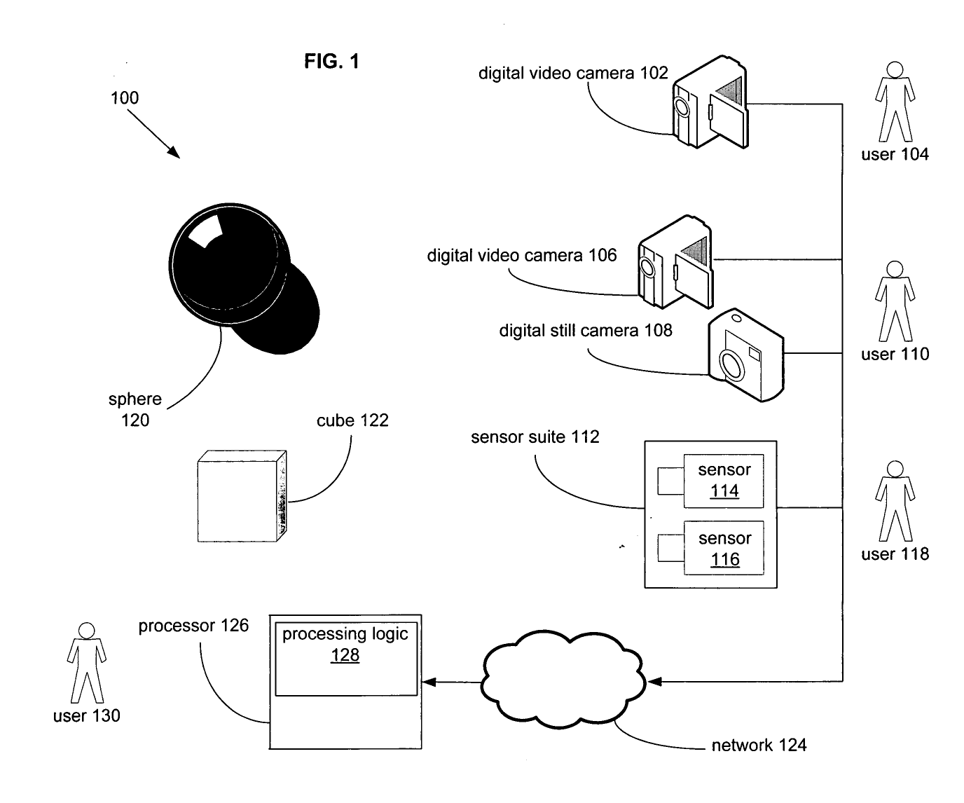

FIG. 1 depicts one implementation of an exemplary environment in which the methods and systems described herein may be represented. In the depicted exemplary environment 100, are illustrated a variety of exemplary sensors: a digital video camera 102 operated by one or more users represented by user 104; a digital video camera 106 used in conjunction with a digital still camera 108, both operated by one or more users represented by user 110; and a sensor suite 112 comprising more than one sensor represented by sensor 114 and sensor 116 (wherein the sensors 114 and 116 may be but need not be physically co-located, and may be but need not be of the same type, e.g., sensor 114 may be an infrared device and sensor 116 may be a radar device), the sensor suite being operated by one or more users represented by user 118. The exemplary sensors represent a variety of devices for the detection and/or the recording and/or the transmission of imagery aspects, e.g., images, including but not limited to digital video cameras, digital still cameras, digital sensor (e.g. CCD or CMOS) arrays, and radar sets. The exemplary users 104, 110, and/or 118 may, for example, operate the exemplary sensors manually or may supervise and/or monitor their automatic operation. The exemplary users 104, 110, and/or 118 may operate the exemplary sensors in physical proximity to the sensors or remotely. The exemplary sensors may also operate autonomously without exemplary users 104, 110, and/or 118.

The exemplary sensors may be used to detect and/or record and/or transmit images of a wide variety of objects, represented in FIG. 1 by exemplary objects, a sphere 120 and a cube 122. The sphere 120 and the cube 122 are representative of any objects or groups of object, images of which may be detectable and/or recordable and/or transmissible by the exemplary sensors, including but not limited to persons, animals, buildings, roads, automobiles, tracks, aircraft, ships, spacecraft, landscape and/or seascape features, vegetation, and/or celestial objects. When used together in any given example herein, the exemplary sphere 120 and the exemplary cube 122 generally represent two distinct objects which may or may not be of the same or of a similar type, except where otherwise required by the context, e.g., a sphere 120 and a cube 122 used together in an example may represent a first particular object and a second particular object, e.g., a particular person and a particular building, or a particular first aircraft and a particular second aircraft, respectively. When used alone in any given example herein, the designated exemplary object, e.g., the sphere 120 or the cube 122, generally represents the same object, except where otherwise required by the context, e.g., a sphere 120 used alone in an example generally represents a single object, e.g., a single building, and a cube 122 used alone generally represents a single object, e.g., a particular person.

Each of the exemplary sensors may detect and/or record and/or transmit images of the exemplary objects in a variety of combinations and sequences. For instance, the digital video camera 102 may detect and/or record and/or transmit an image of the sphere 120 and then an image of the cube 122 sequentially, in either order; and/or, the digital video camera 106 may detect and/or record and/or transmit a single image of the sphere 120 and the cube 122 together.

Similarly, the digital video camera 106 may detect and/or record and/or transmit an image of the sphere 120 and of the cube 122 sequentially, in either order, and/or of the sphere 120 and the cube 122 together, before, after, partially simultaneously with, or simultaneously with an operation of the digital still camera 108. The digital still camera 108 may detect and/or record and/or transmit an image of the sphere 120 and of the cube 122 sequentially, in either order, and/or of the sphere 120 and the cube 122 together, before, after, partially simultaneously with, or simultaneously with an operation of the digital video camera 106.

Similarly, the sensor 114 and the sensor 116 of the sensor suite 112 may detect and/or record and/or transmit an image of the sphere 120 and then of the cube 122 sequentially, in either order, and/or of the sphere 120 and the cube 122 together, before, after, partially simultaneously with, or simultaneously with respect to each other.

Such images may be recorded and/or transmitted via a computer or computers represented by the network 124 and/or directly to a processor 126 and/or processing logic 128, which accept data representing imagery aspects of the exemplary objects. The processor 126 represents one or more processors that may be, for example, one or more computers, including but not limited to one or more laptop computers, desktop computers, and/or other types of computers. The processing logic may be software and/or hardware and/or firmware associated with the processor 126 and capable of accepting and/or processing data representing imagery aspects of the exemplary objects from the exemplary sensors. Such processing may include but is not limited to comparing at least a portion of the data from one sensor with at least a portion of the data from the other sensor, and/or applying a mathematical algorithm to at least a portion of the data from one sensor with at least a portion of the data from the other sensor. Such processing may also include, but is not limited to, deriving third data from the combining at least a portion of the data from one sensor with at least a portion of the data from another sensor.

The exemplary sensors may be capable of detecting and/or recording and/or transmitting one or more imagery aspects of the exemplary objects, the one or more imagery aspects being defined in part, but not exclusively, by exemplary parameters such as focal length, aperture (f-stop being one parameter for denoting aperture), t-stop, shutter speed, sensor sensitivity (such as film sensitivity (e.g., film speed) and/or digital sensor sensitivity), exposure (which may be varied by varying, e.g., shutter speed and/or aperture), frequency and/or wavelength, focus, depth of field, white balance (and/or white point, color temperature, and/or micro reciprocal degree or “mired”), and/or flash. Some or all of the parameters that may define at least in part imagery aspects may have further defining parameters. For example, a frequency and/or wavelength parameter may be associated with one or more bandwidth parameters; and a flash parameter may be associated with one or more parameters for, e.g., duration, intensity, and/or special distribution. Note that although certain examples herein discuss bracketing and/or imagery aspects and/or exemplary parameters in the context of more or less “still” images for sake of clarity, techniques described herein are also applicable to streams of images, such as would typically be produced by digital video cameras 102/106 and thus the use of such, and other, exemplary terms herein are meant to encompass both still and video bracketing/aspects/parameters/etc. unless context dictates otherwise. For instance, the bracketing might include bracketing over, say, 20 frames of video.

Each of the exemplary sensors may detect and/or record and/or transmit one or more imagery aspects of an exemplary object at more than one setting of each of the available parameters, thereby bracketing the exemplary object. Generally, “bracketing” includes the imagery technique of making several images of the same object or objects using different settings, typically with a single imagery device such as digital video camera 106. For example, the digital video camera 106 may detect and/or record and/or transmit a series of imagery aspects of the cube 122 at a number of different f-stops; before, after, partially simultaneously with, and/or simultaneously with that series of imagery aspects, another digital video camera 106 and/or another type of sensor, such as sensor 114 may detect and/or record and/or transmit a series of imagery aspects of the sphere 120 and of the cube 122 at a number of different white balances. The processor 126 and/or the processing logic 128 may then accept, via the network 124 or directly, data representing the imagery aspects detected and/or recorded and/or transmitted by the digital video cameras 106 or by the digital video camera 106 and the sensor 114. The processor 126 and/or the processing logic 128 may then combine at least a portion of the data from one of the sensors with at least a portion of the data from the other sensor, e.g., comparing the data from the two sensors. For example, deriving an identity of color and orientation from the bracketing imagery aspect data of two cubes 122 from digital video camera 106 and sensor 114.

Exemplary digital video cameras 102 and/or 106 may also be capable of detecting and/or recording and/or transmitting video and/or audio input as one or more data streams representing the video and/or audio information. Exemplary users 104 and/or 110 and/or another person and/or entity such as user 130 may provide input to the digital video camera 102 and/or the processor 126 and/or the processing logic 128 to select at least a portion of a data stream representing the video and/or audio information for retention at high resolution. Such high resolution retention includes but is not limited to storage of a relatively large amount of data, compared to storage of portions of the data stream not selected for high resolution retention. For example, the user 130 may provide input to the processor 126 and/or the processor logic 128 to identify a portion of a video and/or audio data stream for retention at high resolution. The processor 126 and/or the processor logic 128 may accept the input, enabling the identified portion to be stored with high fidelity relative to the source video and/or audio and with a relatively small proportion of data (if any) discarded, while the portion or portions not selected may be stored at a relatively lower resolution, e.g., with a higher proportion of data discarded to save storage resources. With respect to this example, input for the identification of a particular portion for retention at a relatively higher resolution does not preclude input for the storage of a distinct and/or an overlapping portion of the data stream at a distinct higher resolution compared to the retention resolution of one or more portions not identified for retention at a higher resolution, e.g., one or more portions of a data stream may be identified for retention at one or more relatively high resolutions. A particular portion identified for retention at high resolution may include more than one data set that may generally be considered to constitute a “frame” in a video and/or audio data stream. With respect to this example, digital video cameras 102 and/or 106 are representative of any sensor or sensor suite capable of detecting and/or recording and/or transmitting video and/or audio input as one or more data streams representing the video and/or audio information.

Those skilled in the art will appreciate that the explicitly described examples involving the exemplary sensors (the digital video camera 102, the digital video camera 106, the digital still camera 108, and the sensor suite 112 including sensor 114 and sensor 116), the exemplary users (users 104, 110, and 118), the exemplary objects (the sphere 120 and the cube 122), the network 124, the exemplary processor 126, and the exemplary processing logic 128 constitute only a few of the aspects illustrated by FIG. 1.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

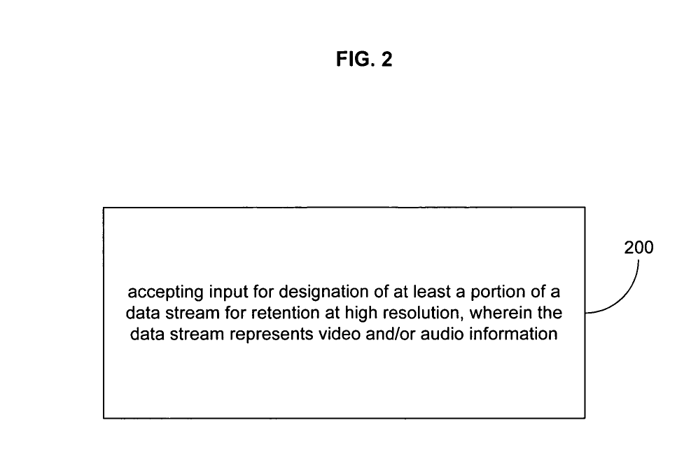

FIG. 2 depicts a high-level logic flowchart of an operational process. Operation 200 shows accepting input for designation of at least a portion of a data stream for retention at high resolution, wherein the data stream represents video and/or audio information (e.g., accepting input, via the processor 126 and/or processing logic 128, for designation of a five-second portion of a video and/or audio data stream from the digital video camera 102 for retention in data storage at a resolution sufficient to reproduce the original video and/or audio at high fidelity).

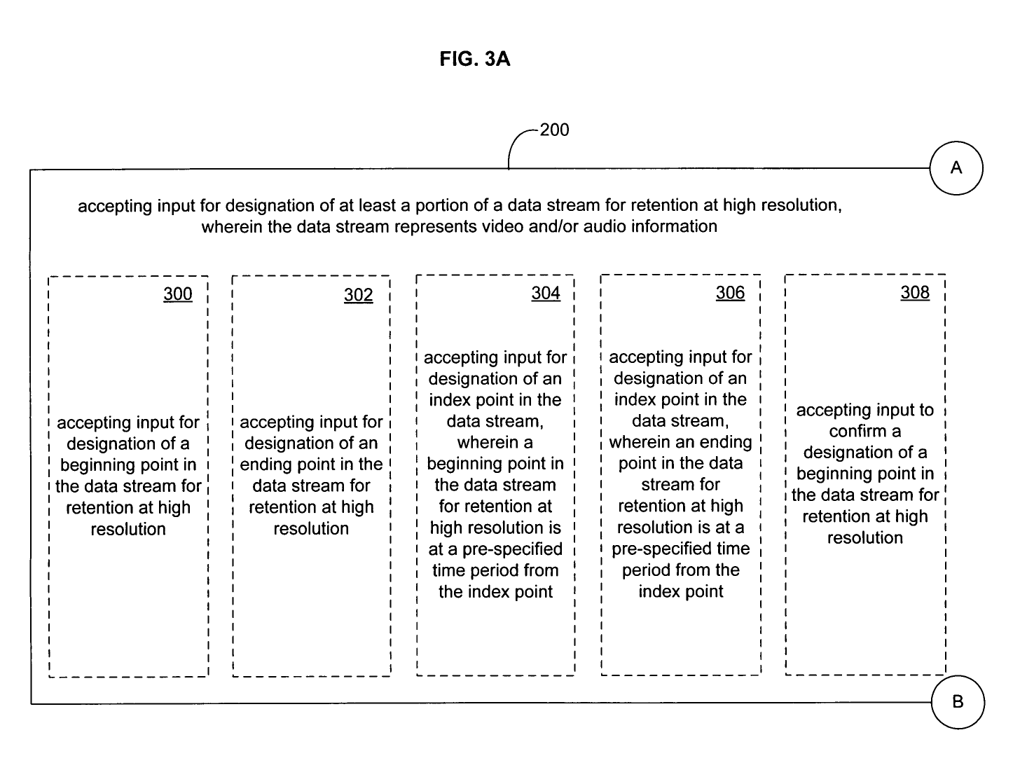

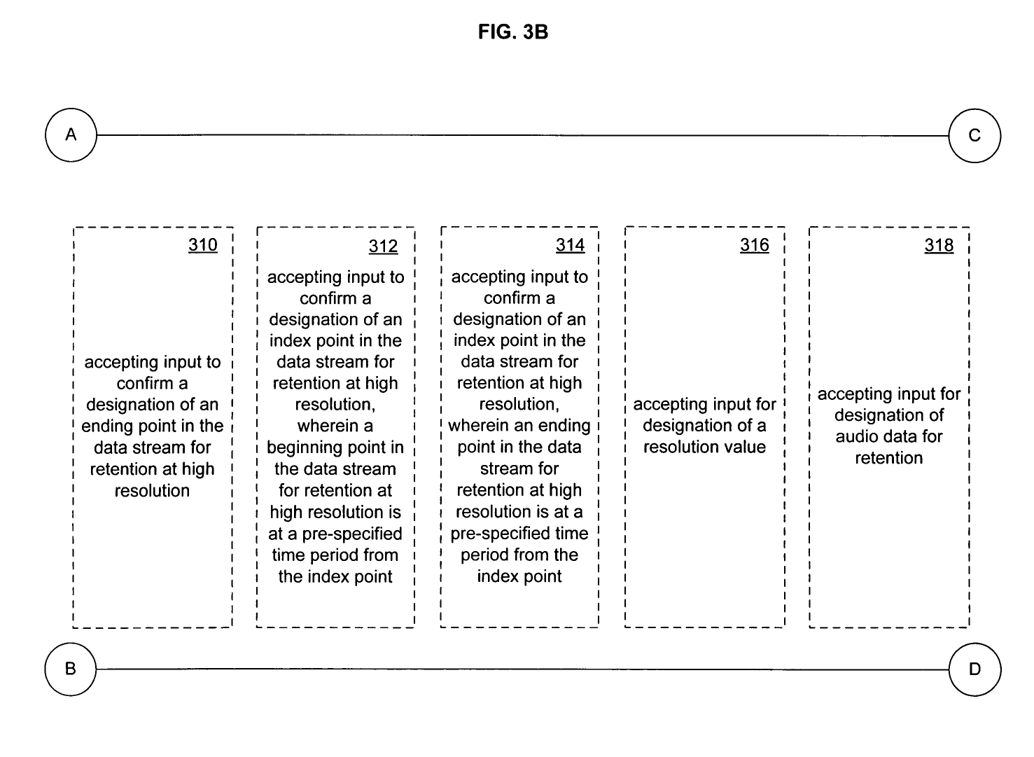

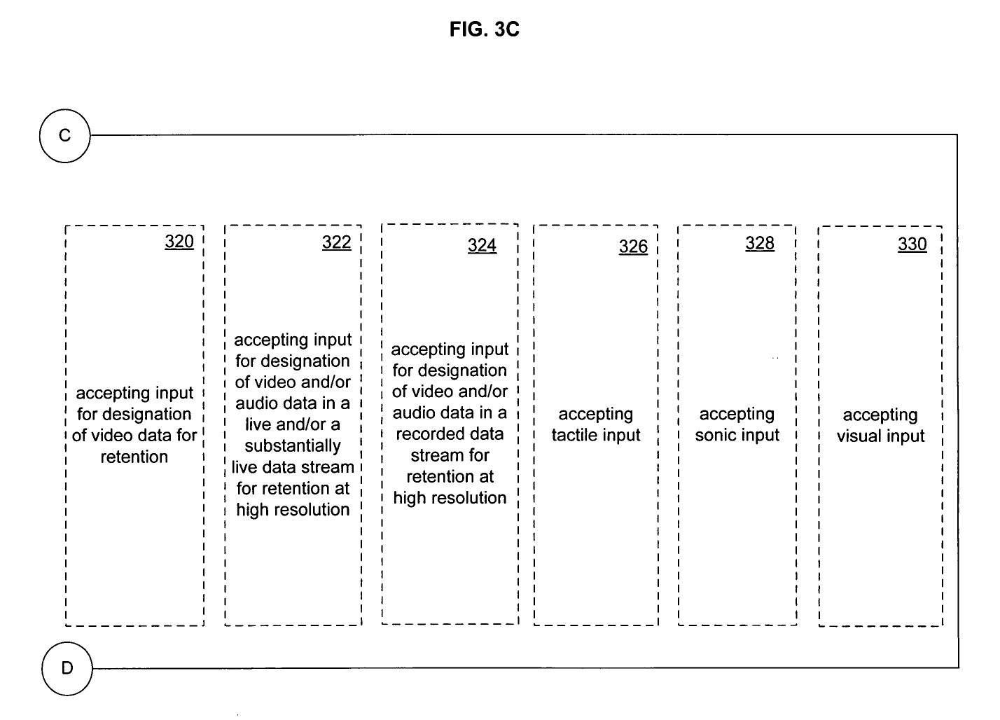

FIG. 3 shows several alternative implementations of the high-level logic flowchart of FIG. 2. Operation 200—accepting input for designation of at least a portion of a data stream for retention at high resolution, wherein the data stream represents video and/or audio information—may include one or more of the following operations: 300, 302, 304, 306, 308, 310, 312, 314, 316, 318, 320, 322, 324,326, 328, and/or 330.

Operation 300 shows accepting input for designation of a beginning point in the data stream for retention at high resolution (e.g., accepting input, via the processor 126 and/or processing logic 128, for designation of a beginning point of a three-second portion of a video and/or audio data stream from the digital video camera 106 for retention in data storage at a resolution sufficient to reproduce the original video and/or audio at high fidelity).

Operation 302 depicts accepting input for designation of an ending point in the data stream for retention at high resolution (e.g., accepting input, via the processor 126 and/or processing logic 128, for designation of an ending point of a three-second portion of a video and/or audio data stream from the digital video camera 106 for retention in data storage at a resolution sufficient to reproduce the original video and/or audio at high fidelity).

Operation 304 illustrates accepting input for designation of an index point in the data stream, wherein a beginning point in the data stream for retention at high resolution is at a pre-specified time period from the index point (e.g., accepting input, via the processor 126 and/or processing logic 128, for designation of an index point, with respect to which a beginning point is a pre-specified three seconds before, of a six-second portion of a video and/or audio data stream from the digital video camera 106 for retention in data storage at a resolution sufficient to reproduce the original video and/or audio at high fidelity).

Operation 306 shows accepting input for designation of an index point in the data stream, wherein an ending point in the data stream for retention at high resolution is at a pre-specified time period from the index point (e.g., accepting input, via the processor 126 and/or processing logic 128, for designation of an index point, with respect to which an ending point is a pre-specified three seconds before, of a six-second portion of a video and/or audio data stream from the digital video camera 106 for retention in data storage at a resolution sufficient to reproduce the original video and/or audio at high fidelity).

Operation 308 depicts accepting input to confirm a designation of a beginning point in the data stream for retention at high resolution (e.g., accepting input, via the processor 126 and/or processing logic 128, for confirmation of a selected beginning point of a ten-second portion of a video and/or audio data stream from the digital video camera 102 for retention in data storage at a resolution sufficient to reproduce the original video and/or audio at high fidelity).

Operation 310 shows accepting input to confirm a designation of an ending point in the data stream for retention at high resolution (e.g., accepting input, via the processor 126 and/or processing logic 128, for confirmation of a selected ending point of a ten-second portion of a video and/or audio data stream from the digital video camera 102 for retention in data storage at a resolution sufficient to reproduce the original video and/or audio at high fidelity).

Operation 312 illustrates accepting input to confirm a designation of an index point in the data stream for retention at high resolution, wherein a beginning point in the data stream for retention at high resolution is at a pre-specified time period from the index point (e.g., accepting input, via the processor 126 and/or processing logic 128, for confirmation of a selected index point, with respect to which a beginning point is a pre-specified five seconds before, of a ten-second portion of a video and/or audio data stream from the digital video camera 102 for retention in data storage at a resolution sufficient to reproduce the original video and/or audio at high fidelity).

Operation 314 shows accepting input to confirm a designation of an index point in the data stream for retention at high resolution, wherein an ending point in the data stream for retention at high resolution is at a pre-specified time period from the index point (e.g., accepting input, via the processor 126 and/or processing logic 128, for confirmation of a selected index point, with respect to which an ending point is a pre-specified five seconds before, of a ten-second portion of a video and/or audio data stream from the digital video camera 106 for retention in data storage at a resolution sufficient to reproduce the original video and/or audio at high fidelity).

Operation 316 illustrates accepting input for designation of a resolution value (e.g., accepting input, via the processor 126 and/or processing logic 128, for designation of a retention resolution of 1.00 Mb/second, and/or of 95% of data present, of a ten-second portion of a video and/or audio data stream from the digital video camera 102 for retention in data storage).

Operation 318 shows accepting input for designation of audio data for retention (e.g., accepting input, via the processor 126 and/or processing logic 128, for designation of video of a seven-second portion of a video and/or audio data stream from the digital video camera 102 to be retained in data storage).

Operation 320 depicts accepting input for designation of video data for retention (e.g., accepting input, via the processor 126 and/or processing logic 128, for designation of audio of a two-minute portion of a video and/or audio data stream from the digital video camera 102 to be retained in data storage).

Operation 322 illustrates accepting input for designation of video and/or audio data in a live and/or a substantially live data stream for retention at high resolution (e.g., accepting input, via the processor 126 and/or processing logic 128, for designation of a three-second portion of a video and/or audio data stream from the digital video camera 106 for retention in data storage at a resolution sufficient to reproduce the original video and/or audio at high fidelity, where the data stream is originating from the digital video camera 106 as, or substantially as, the data is being detected and/or recorded and/or transmitted).

Operation 324 shows accepting input for designation of video and/or audio data in a recorded data stream for retention at high resolution (e.g., accepting input, via the processor 126 and/or processing logic 128, for designation of a three-second portion of a video and/or audio data stream from the digital video camera 106 for retention in data storage at a resolution sufficient to reproduce the original video and/or audio at high fidelity, where the data stream is originating from the digital video camera 106 as, or substantially as, the data is being played backed from data storage).

Operation 326 depicts accepting tactile input (e.g., accepting input, via the processor 126 and/or processing logic 128, for designation of a one minute portion of a video and/or audio data stream from the digital video camera 102 for retention in data storage at a resolution sufficient to reproduce the original video and/or audio at high fidelity, where the input is initiated by a user 130 mechanically manipulating an interface device and/or feature).

Operation 328 illustrates accepting sonic input (e.g., accepting input, via the processor 126 and/or processing logic 128, for designation of a twelve-second portion of a video and/or audio data stream from the digital video camera 106 for retention in data storage at a resolution sufficient to reproduce the original video and/or audio at high fidelity, where the input is initiated by a user 130 speaking into an interface device and/or feature).

Operation 330 shows accepting visual input (e.g., accepting input, via the processor 126 and/or processing logic 128, for designation of a four-minute portion of a video and/or audio data stream from the digital video camera 102 for retention in data storage at a resolution sufficient to reproduce the original video and/or audio at high fidelity, where the input is initiated by a user 130 interacting with a video input device such as a camera and/or a visual component of a graphical user interface).

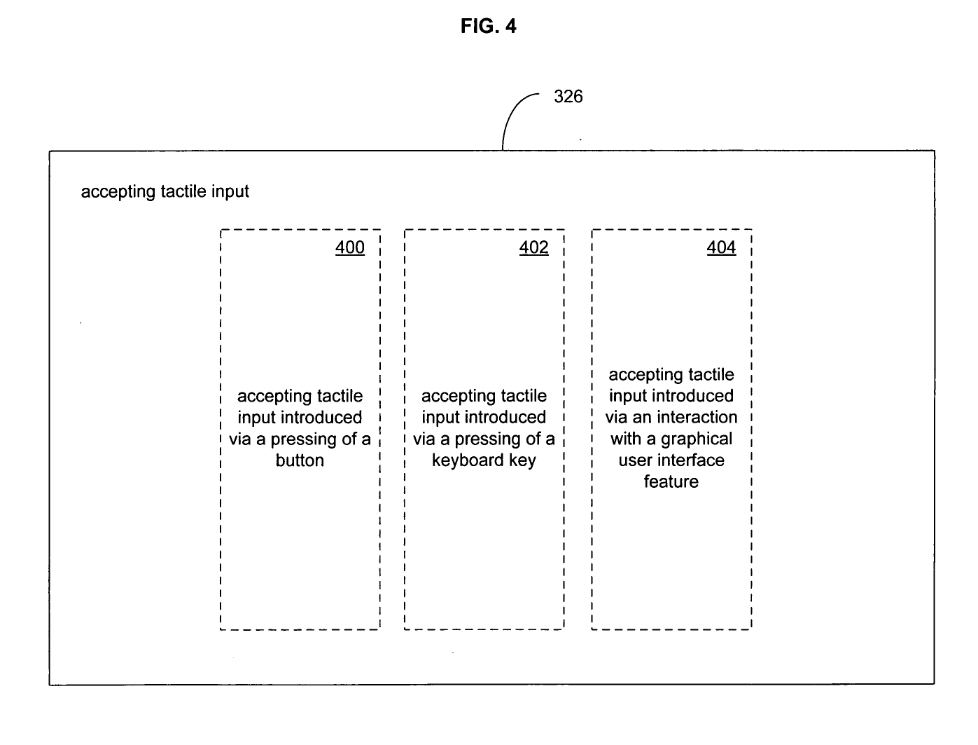

FIG. 4 shows several alternative implementations of the high-level logic flowchart of FIG. 3. Operation 326—accepting tactile input—may include one or more of the following operations: 400, 402, and/or 404.

Operation 400 shows accepting tactile input introduced via a pressing of a button (e.g., accepting input, via the processor 126 and/or processing logic 128, for designation of a one-minute portion of a video and/or audio data stream from the digital video camera 102 for retention in data storage at a resolution sufficient to reproduce the original video and/or audio at high fidelity, where the input is initiated by a user 130 mechanically manipulating a button on a mouse input device).

Operation 402 depicts accepting tactile input introduced via a pressing of a keyboard key (e.g., accepting input, via the processor 126 and/or processing logic 128, for designation of a forty-second portion of a video and/or audio data stream from the digital video camera 106 for retention in data storage at a resolution sufficient to reproduce the original video and/or audio at high fidelity, where the input is initiated by a user 130 mechanically manipulating a computer keyboard key).

Operation 404 illustrates accepting tactile input introduced via an interaction with a graphical user interface feature (e.g., accepting input, via the processor 126 and/or processing logic 128, for designation of a three-second portion of a video and/or audio data stream from the digital video camera 102 for retention in data storage at a resolution sufficient to reproduce the original video and/or audio at high fidelity, where the input is initiated by a user 130 mechanically interacting with a button included in a graphical user interface).

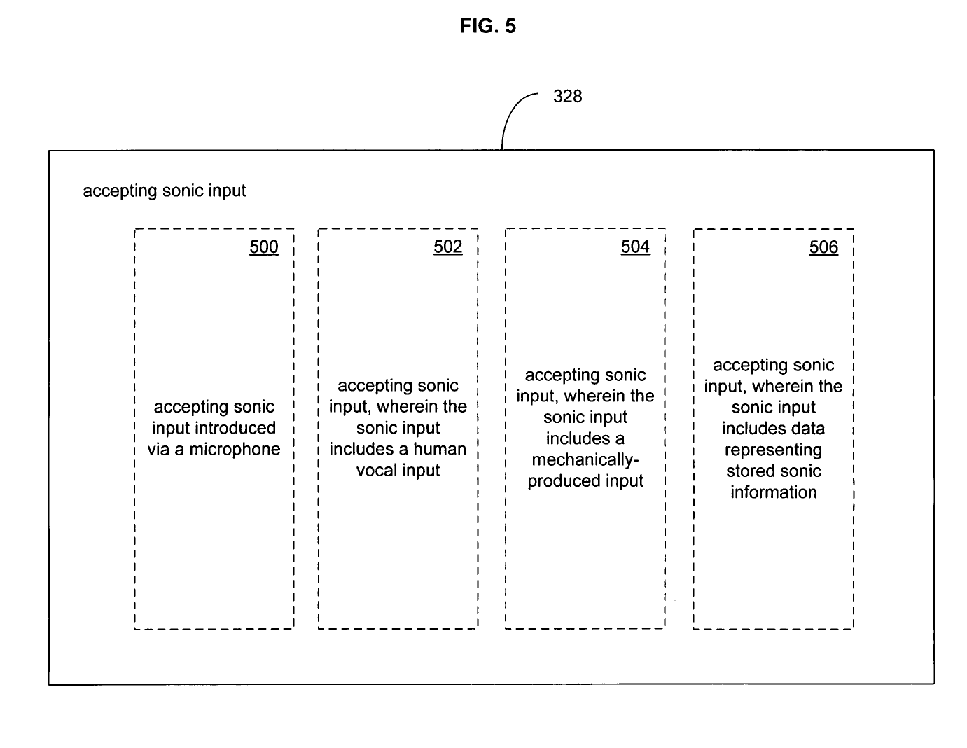

FIG. 5 shows several alternative implementations of the high-level logic flowchart of FIG. 3. Operation 328—accepting sonic input—may include one or more of the following operations: 500, 502, 504, and/or 506.

Operation 500 shows accepting sonic input introduced via a microphone (e.g., accepting input, via the processor 126 and/or processing logic 128, for designation of a ten-second portion of a video and/or audio data stream from the digital video camera 106 for retention in data storage at a resolution sufficient to reproduce the original video and/or audio at high fidelity, where the input is initiated by a user 130 causing a sound to be made that is detected by a microphone).

Operation 502 depicts accepting sonic input, wherein the sonic input includes a human vocal input (e.g., accepting input, via the processor 126 and/or processing logic 128, for designation of a ten-second portion of a video and/or audio data stream from the digital video camera 106 for retention in data storage at a resolution sufficient to reproduce the original video and/or audio at high fidelity, where the input is initiated by a user 130 speaking into a microphone).

Operation 504 illustrates accepting sonic input, wherein the sonic input includes a mechanically-produced input (e.g., accepting input, via the processor 126 and/or processing logic 128, for designation of a two-second portion of a video and/or audio data stream from the digital video camera 102 for retention in data storage at a resolution sufficient to reproduce the original video and/or audio at high fidelity, where the input is initiated by a user 130 causing a sound to be made with a speaker).

Operation 506 shows accepting sonic input, wherein the sonic input includes data representing stored sonic information (e.g., accepting input, via the processor 126 and/or processing logic 128, for designation of a one-minute portion of a video and/or audio data stream from the digital video camera 102 for retention in data storage at a resolution sufficient to reproduce the original video and/or audio at high fidelity, where the input is initiated by a playback of a recording of a user 130 speaking into a microphone).

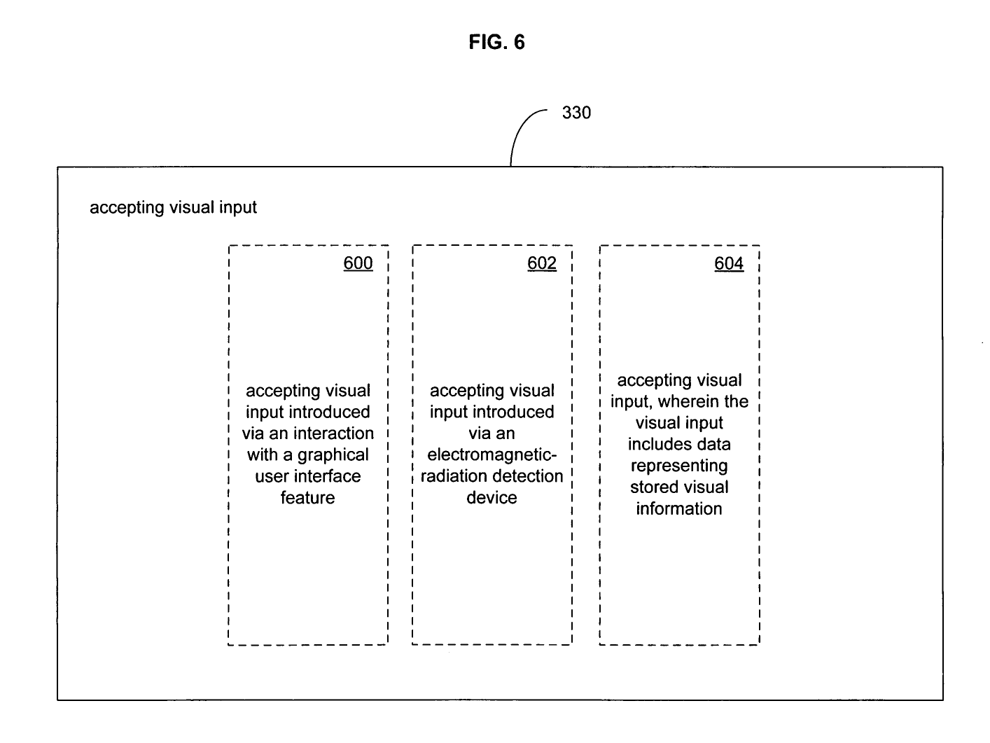

FIG. 6 shows several alternative implementations of the high-level logic flowchart of FIG. 3. Operation 330—accepting visual input—may include one or more of the following operations: 600, 602, and/or 604.

Operation 600 shows accepting visual input introduced via an interaction with a graphical user interface feature (e.g., accepting input, via the processor 126 and/or processing logic 128, for designation of a five-second portion of a video and/or audio data stream from the digital video camera 102 for retention in data storage at a resolution sufficient to reproduce the original video and/or audio at high fidelity, where the input is initiated by a user 130 interacting with a button included in a visual presentation of a graphical user interface).

Operation 602 depicts accepting visual input introduced via an electromagnetic-radiation detection device (e.g., accepting input, via the processor 126 and/or processing logic 128, for designation of a five-second portion of a video and/or audio data stream from the digital video camera 102 for retention in data storage at a resolution sufficient to reproduce the original video and/or audio at high fidelity, where the input is initiated by a user 130 making a sign that is detected by a camera).

Operation 604 illustrates accepting visual input, wherein the visual input includes data representing stored visual information (e.g., accepting input, via the processor 126 and/or processing logic 128, for designation of a five-second portion of a video and/or audio data stream from the digital video camera 102 for retention in data storage at a resolution sufficient to reproduce the original video and/or audio at high fidelity, where the input is initiated by a playback of a video recording of a user 130 making a sign that is detected by a camera).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a ” or “an ” (e.g., “a ” and/or “an ” should typically be interpreted to mean “at least one ” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations, ” without other modifiers, typically means at least two recitations, or two or more recitations). Furthermore, in those instances where a convention analogous to “at least one of A, B, and C, etc. ” is used, in general such a construction is intended in the sense one having skill in the art would understand the convention (e.g., “a system having at least one of A, B, and C ” would include but not be limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g., “a system having at least one of A, B, or C ” would include but not be limited to systems that have A alone, B alone, C alone, A and B together, A and C together, B and C together, and/or A, B, and C together, etc.).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A program product related to data management, the program product comprising:
a signal-bearing medium bearing
one for more instructions for accepting input for designation of at least a portion of a data stream for retention at high resolution, wherein the data stream represents video and/or audio information.

31. (canceled)

32. (canceled)

33. The program product of claim 30, wherein the one or more instructions for accepting input for designation of at least a portion of a data stream for retention at high resolution, wherein the data stream represents video and/or audio information further comprise:
one or more instructions for accepting input for designation of a beginning point in the data stream for retention at high resolution.

34. The program product of claim 30, wherein the one or more instructions for accepting input for designation of at least a portion of a data stream for retention at high resolution, wherein the data stream represents video and/or audio information further comprise:
one or more instructions for accepting input for designation of an ending point in the data stream for retention at high resolution.

35. The program product of claim 30, wherein the one or more instructions for accepting input for designation of at least a portion of a data stream for retention at high resolution, wherein the data stream represents video and/or audio information further comprise:
one or more instructions for accepting input for designation of an index point in the data stream, wherein a beginning point in the data stream for retention at high resolution is at a pre-specified time period from the index point.

36. The program product of claim 30, wherein the one or more instructions for accepting input for designation of at least a portion of a data stream for retention at high resolution, wherein the data stream represents video and/or audio information further comprise:
one or more instructions for accepting input for designation of an index point in the data stream, wherein an ending point in the data stream for retention at high resolution is at a pre-specified time period from the index point.

37. The program product of claim 30, wherein the one or more instructions for accepting input for designation of at least a portion of a data stream for retention at high resolution, wherein the data stream represents video and/or audio information further comprise:
one or more instructions for accepting input to confirm a designation of a beginning point in the data stream for retention at high resolution.

38. The program product of claim 30, wherein the one or more instructions for accepting input for designation of at least a portion of a data stream for retention at high resolution, wherein the data stream represents video and/or audio information further comprise:
one or more instructions for accepting input to confirm a designation of an ending point in the data stream for retention at high resolution.

39. The program product of claim 30, wherein the one or more instructions for accepting input for designation of at least a portion of a data stream for retention at high resolution, wherein the data stream represents video and/or audio information further comprise:
one or more instructions for accepting input to confirm a designation of an index point in the data stream for retention at high resolution, wherein a beginning point in the data stream for retention at high resolution is at a pre-specified time period from the index point.

40. The program product of claim 30, wherein the one or more instructions for accepting input for designation of at least a portion of a data stream for retention at high resolution, wherein the data stream represents video and/or audio information further comprise:
one or more instructions for accepting input to confirm a designation of an index point in the data stream for retention at high resolution, wherein an ending point in the data stream for retention at high resolution is at a pre-specified time period from the index point.

41. The program product of claim 30, wherein the one or more instructions for accepting input for designation of at least a portion of a data stream for retention at high resolution, wherein the data stream represents video and/or audio information further comprise:
one or more instructions for accepting input for designation of a resolution value.

42. The program product of claim 30, wherein the one or more instructions for accepting input for designation of at least a portion of a data stream for retention at high resolution, wherein the data stream represents video and/or audio information further comprise:
one or more instructions for accepting input for designation of audio data for retention.

43. The program product of claim 30, wherein the one or more instructions for accepting input for designation of at least a portion of a data stream for retention at high resolution, wherein the data stream represents video and/or audio information further comprise:
one or more instructions for accepting input for designation of video data for retention.

44. The program product of claim 30, wherein the one or more instructions for accepting input for designation of at least a portion of a data stream for retention at high resolution, wherein the data stream represents video and/or audio information further comprise:
one or more instructions for accepting input for designation of video and/or audio data in a live and/or a substantially live data stream for retention at high resolution.

45. The program product of claim 30, wherein the one or more instructions for accepting input for designation of at least a portion of a data stream for retention at high resolution, wherein the data stream represents video and/or audio information further comprise:
one or more instructions for accepting input for designation of video and/or audio data in a recorded data stream for retention at high resolution.

46. The program product of claim 30, wherein the one or more instructions for accepting input for designation of at least a portion of a data stream for retention at high resolution, wherein the data stream represents video and/or audio information further comprise:
one or more instructions for accepting tactile input.

47. The program product of claim 46, wherein the one or more instructions for accepting tactile input further comprise:
one or more instructions for accepting tactile input introduced via a pressing of a button.

48. The program product of claim 46, wherein the one or more instructions for accepting tactile input further comprise:
one or more instructions for accepting tactile input introduced via a pressing of a keyboard key.

49. The program product of claim 46, wherein the one or more instructions for accepting tactile input further comprise:
one or more instructions for accepting tactile input introduced via an interaction with a graphical user interface feature.

50. The program product of claim 30, wherein the one or more instructions for accepting input for designation of at least a portion of a data stream for retention at high resolution, wherein the data stream represents video and/or audio information further comprise:
one or more instructions for accepting sonic input.

51. The program product of claim 50, wherein the one or more instructions for accepting sonic input further comprise:
one or more instructions for accepting sonic input introduced via a microphone.

52. (canceled)

53. (canceled)

54. (canceled)

55. (canceled)

56. (canceled)

57. (canceled)

58. (canceled)
